(19) United States
(12) Patent Application Publication
(10) Pub. No.: US 2024/0102440 A1
(43) Pub. Date: Mar. 28, 2024

(54) LIFT-TYPE VERTICAL SHAFT WIND OR WATER TURBINE

(71) Applicant: Rikiya ABE, Naka-gun, Kanagawa (JP)

(72) Inventors: Rikiya ABE, Naka-gun, Kanagawa (JP); Takahiko ITO, Yokohama-shi, Kanagawa (JP)

(21) Appl. No.: 17/768,581

(22) PCT Filed: Sep. 17, 2020
(86) PCT No.: PCT/JP2020/035170

§ 371 Date: Apr. 13, 2022

(30) Foreign Application Priority Data
Oct. 15, 2019 (JP) 2019-188506

(51) Int. Cl. F03B 3/14; F03D 3/00

(52) U.S. Cl. CPC F03B 3/145; F03D 3/005; F05B 2260/70

(57) ABSTRACT

A water or wind turbine in which fatigue fracture is less likely to be generated in a rotation shaft is provided. A wind turbine comprises: a rotation shaft extending in the vertical direction; a plurality of arms extending horizontally from the rotation shaft and formed at equal intervals along the rotation direction; and a plurality of wings attached to tips of the arms and extending in the upper/lower direction, and the rotation shaft is rotated by lift generated on the wings, wherein cross sections of the wings have a uniform shape and a uniform area from upper ends of the wings to lower ends of the wings, wherein seen from the extending direction of the rotation shaft, the plurality of wings are projected on the entire circumference of a single virtual circular ring C whose center is on the rotation shaft, and wherein lengths of the wings in the vertical direction are equal over the entire circumference.

### TECHNICAL FIELD

The present invention relates to a lift-type vertical shaft wind or water turbine (hereinafter referred to as “wind or water turbine”) in which a rotation shaft is rotated by lift generated on a wing.

### BACKGROUND ART

As one of turbomachines for continuously converting a kind of energy to another kind of energy through a rotating impeller, a wind turbine is known which converts wind energy of natural wind into mechanical energy by the rotating impeller.

Wind turbines are classified into horizontal shaft wind turbines, in which the rotation shaft of the impeller is horizontal to the ground, and vertical shaft wind turbines, in which the rotation shaft of the impeller is perpendicular to the ground.

Further, each wind turbine is classified into a drag-type, in which the impeller is rotated by drag, and a lift-type, in which the impeller is rotated by lift.

In the horizontal shaft wind turbine, it is necessary to face the rotation surface of the impeller in the wind direction. Thus, the rotation surface of the impeller must follow the change of the wind direction in order to constantly rotate the impeller.

On the other hand, since the vertical shaft wind turbine does not have directivity with respect to the wind direction, it is not necessary to have a mechanism for following the wind direction, so that the device configuration can be simplified.

The drag-type wind turbine is characterized in that the wind turbine efficiency (efficiency of obtaining energy from wind) is high when the tip speed ratio (ratio of the tip speed of the impeller to the wind speed) is low.

On the other hand, the lift-type wind turbine is characterized in that the wind turbine efficiency is high when the tip speed ratio is high.

Due to the above characteristics, lift-type vertical shaft wind turbines have been attracting attention in recent years.

As such a lift-type vertical shaft wind turbine, a wind turbine is known which has a plurality of rotation wings having a streamlined cross-sectional shape and a substantially rectangular plate shape, a rotation shaft connected to a rotor of a generator and arranged in the vertical direction, a first rotation shaft penetration member fixed to the rotation shaft, and a second rotation shaft penetration member fixed to the rotation shaft at a position away from the first rotation shaft penetration member (for example, in Patent Literature 1).

The wind turbine further has a first support member, one end of which is fixed to the first rotation shaft penetration member and the other end of which is attached to one of the rotation shaft side surfaces of the plurality of rotation wings, and a plurality of second support members, one end of which is fixed to the second rotation shaft penetration member and the other end of which is attached to one of the rotation shaft side surfaces of the plurality of rotation wings.

Further, seen from the extending direction of the rotation shaft, a pair of the first support member and the second support member that support one of the plurality of rotation wings is arranged with a predetermined opening angle between them.

### CITATION LIST

### Patent Literature

[Patent Literature 1] JP 2005-240632 A

### SUMMARY OF INVENTION

### Technical Problem

However, in the above wind turbine, since there are a portion where the wing exists and a portion where the wing does not exist in a plan view, the wind energy obtained from wind changes periodically depending on the angle of the rotation axis.

Thus, the moment and the axial force applied to the rotation shaft change periodically depending on the angle of the rotation shaft. Therefore, fatigue fracture may be generated in the rotation shaft due to the application of the periodic moment and axial force.

The present invention is for solving the problem of the prior art as described above, that is, an object of the present invention is to provide a water or wind turbine in which fatigue fracture is less likely to be generated in the rotation shaft.

### Solution to Problem

The invention according to claim 1 is a lift-type vertical shaft wind or water turbine comprising: a rotation shaft extending in the vertical direction; a plurality of arms extending horizontally from the rotation shaft and formed at equal intervals along the rotation direction; and a plurality of wings attached to tips of the arms and extending in the upper/lower direction, and the rotation shaft being rotated by lift generated on the wings, wherein cross sections of the wings have a uniform shape and a uniform area from upper ends of the wings to lower ends of the wings, wherein seen from the extending direction of the rotation shaft, the plurality of wings are projected on the entire circumference of a single virtual circular ring whose center is on the rotation shaft, and wherein lengths of the wings in the vertical direction are equal over the entire circumference, thereby the above-described problem can be solved.

The invention according to claim 2 is, in addition to the configuration of the lift-type vertical shaft wind or water turbine according to claim 1, in that the wing is composed of an upper wing, which extends upward from the arm and extends in the direction opposite to the rotation direction, and a lower wing, which extends downward from the arm and extends in the direction opposite to the rotation direction, and wherein the shape of the wing is V-shaped in a side view, thereby the above-described problem can be further solved.

The invention according to claim 3 is, in addition to the configuration of the lift-type vertical shaft wind or water turbine according to claim 1 or 2, in that the arm has a shaft support mechanism at the tip thereof, which rotatably holds the wing about the vertical direction as a rotation axis, wherein an attack angle adjustment mechanism for adjusting an attack angle of the wing is provided between the arm and the wing, and wherein when rotation speed of the rotation shaft is slower than predetermined rotation speed, the attack angle adjustment mechanism does not change the attack angle of the wing, and when the rotation speed of the rotation shaft becomes the predetermined rotation speed or more, the attack angle adjustment mechanism changes the attack angle of the wing so as to reduce lift or increase drag generated on the wing, thereby the above-described problem can be further solved.

### Advantageous Effect of Invention

According to the lift-type vertical shaft wind or water turbine in the invention according to claim 1, cross sections of the wings have a uniform shape and a uniform area from upper ends of the wings to lower ends of the wings. Thus, lift generated on the wing is uniform from the upper end of the wing to the lower end of the wing, and thrust distribution due to vertical lift on the wing is also uniform. Therefore, the torsion moment is less likely to be generated around the extending direction of the arm, so that fatigue fracture in the arm can be less likely to be generated.

Further, seen from the extending direction of the rotation shaft, the plurality of wings are projected on the entire circumference of a single virtual circular ring whose center is on the rotation shaft, and lengths of the wings in the vertical direction are equal over the entire circumference. Thus, the wind receiving area of the wing in a side view is almost constant regardless of the rotation position of the rotation shaft. Therefore, the axial force and moment from the arm due to wind received from the direction orthogonal to the rotation direction of the wing are almost constant, so that fatigue fracture in the rotation shaft can be less likely to be generated.

According to the lift-type vertical shaft wind or water turbine in the invention according to claim 2, the wing is composed of an upper wing, which extends upward from the arm and extends in the direction opposite to the rotation direction, and a lower wing, which extends downward from the arm and extends in the direction opposite to the rotation direction, and the shape of the wing is V-shaped in a side view. Thus, in addition to the effect obtained by the lift-type vertical shaft wind or water turbine in the invention according to claim 1, since even wind pressure is applied to the upper wing and the lower wing and the forces applied to the upper wing and the lower wing are always balanced, the force applied to the rotation shaft can be uniform.

Therefore, the force applied to the rotation shaft can be uniformed, and fatigue in a bearing for supporting the rotating shaft is suppressed, so that the life of the wind or water turbine can be extended.

According to the lift-type vertical shaft wind or water turbine in the invention according to claim 3, when rotation speed of the rotation shaft is slower than predetermined rotation speed, the attack angle adjustment mechanism does not change the attack angle of the wing, and when the rotation speed of the rotation shaft becomes the predetermined rotation speed or more, the attack angle adjustment mechanism changes the attack angle of the wing so as to reduce lift or increase drag generated on the wing. Thus, for example, when the rotation speed of the rotation shaft is high as in strong wind, lift generated on the wing is reduced. Therefore, in addition to the effect obtained by the lift-type vertical shaft wind or water turbine in the invention according to claim 1 or 2, the increase in the rotation speed of the rotation shaft can be suppressed.

In other word, since the attack angle adjustment mechanism adjusts the attack angle of the wing according to the centrifugal force applied to the wing, when the rotation speed of the rotation axis increases to some extent, the attack angle of the wing is changed and the rotation speed does not increase.

### BRIEF DESCRIPTION OF DRAWINGS

FIG. 1 is a perspective view of a wind turbine in the first example of the present invention.

FIG. 2 is a plan view of the wind turbine shown in FIG. 1.

FIG. 3 is a side view of the wind turbine shown in FIG. 1.

FIG. 4 is a block diagram of the wind turbine in the second example in the present invention.

### DESCRIPTION OF EMBODIMENTS

The specific embodiment of the present invention may be arbitrary as long as a lift-type vertical shaft wind or water turbine comprises: a rotation shaft extending in the vertical direction; a plurality of arms extending horizontally from the rotation shaft and formed at equal intervals along the rotation direction; and a plurality of wings attached to tips of the arms and extending in the upper/lower direction, and the rotation shaft is rotated by lift generated on the wings, wherein cross sections of the wings have a uniform shape and a uniform area from upper ends of the wings to lower ends of the wings, wherein seen from the extending direction of the rotation shaft, the plurality of wings are projected on the entire circumference of a single virtual circular ring whose center is on the rotation shaft, and wherein lengths of the wings in the vertical direction are equal over the entire circumference, so that fatigue fracture in the rotation shaft is less likely to be generated.

For example, the number of wings in the present invention is not limited as long as the number of wings is a plurality number.

Further, the cross-sectional shape of the wing is not limited as long as the wing generates lift.

Further, the material of the wing is preferably carbon fiber, but the material is not limited thereto, and may be aluminum, for example.

Alternatively, the wing may be made of deformable rubber, cloth, film or the like so that the wing shape is formed by being applied with such as air or liquid pressure and the wing shape is lost by releasing the pressure.

For example, in order to realize the smooth shape of the wing, wire and the like for acting as a bone may be provided in the wing.

In a case of such a wing with variable shape by pressure, the attack angle adjustment function in strong wind can be realized by releasing the pressure.

For example, fluid for operating the lift-type vertical shaft wind or water turbine in the present invention may be liquid or gas, and if the working fluid is liquid, the lift-type vertical shaft wind or water turbine in the present invention acts as a water turbine, and if the working fluid is gas, the lift-type vertical shaft wind or water turbine in the present invention acts as a wind turbine.

### Example 1

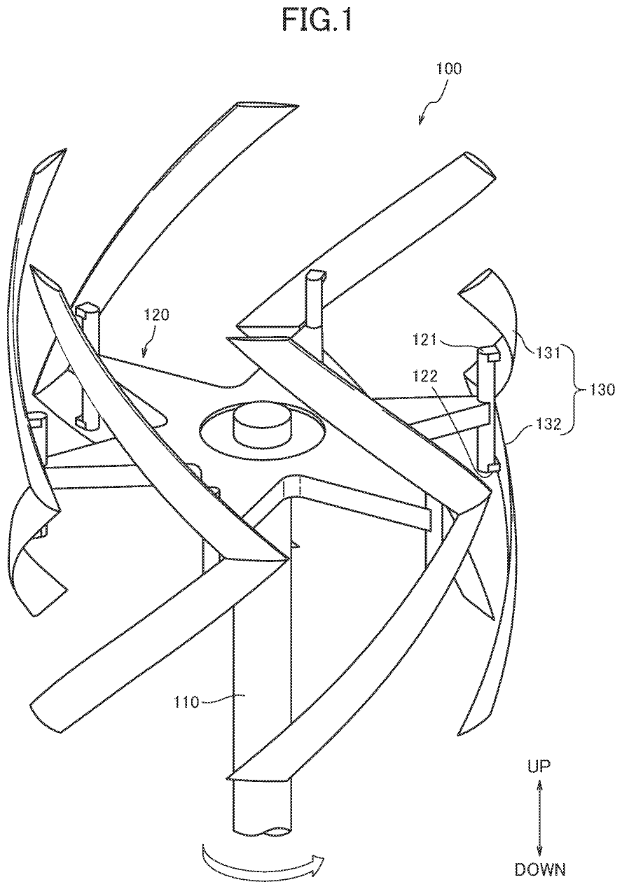

Hereinafter, a wind turbine 100 in the first example of the present invention will be described with reference to FIGS. 1 to 3.

In the following description, components with the same reference numerals in different drawings are the same components, and the descriptions thereof may be omitted.

### <1. Overview of Wind Turbine>

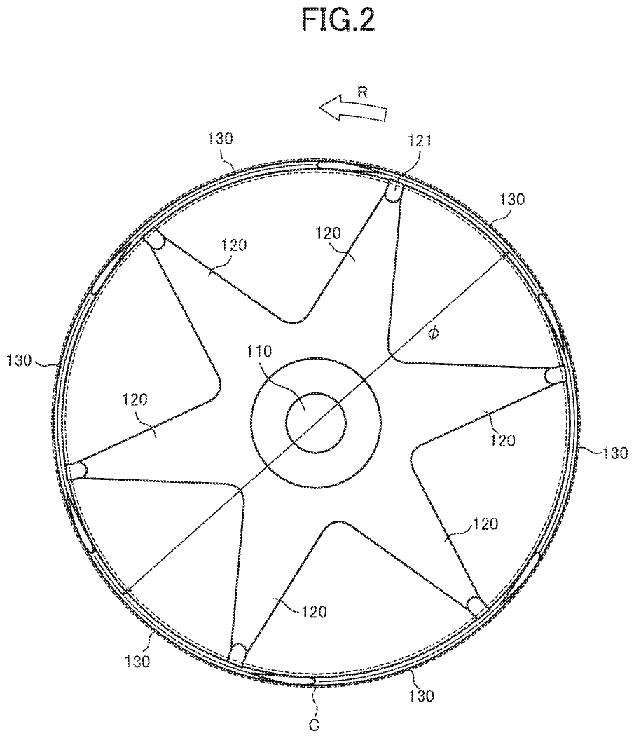

First, the wind turbine 100 in the first example of the present invention will be described with reference to FIGS. 1 and 2.

FIG. 1 is a perspective view of the wind turbine in the first example of the present invention, and FIG. 2 is a plan view of the wind turbine shown in FIG. 1.

The wind turbine 100, which is a lift-type vertical shaft wind turbine, in the first example of the present invention, uses gas as working fluid, and as shown in FIG. 1, includes a rotation shaft 110 extending in the vertical direction, a plurality of arms 120 extending in the horizontal direction (the direction orthogonal to the vertical direction) from the rotation shaft 110 and a plurality of wings 130, each of which is attached to the tip of each arm 120 and extends in the upper/lower direction.

In the wind turbine 100, the rotation shaft 110 is rotated in one direction due to lift generated on the wing 130.

That is, the wind turbine 100 is a lift-type wind turbine that is rotated by lift, and is a vertical-shaft type wind turbine whose rotation shaft faces in the vertical direction.

The rotation shaft 110 has a circular cross-sectional shape, the lower end thereof is connected to a generator (not shown), and the arm 120 is formed on the upper end side thereof.

As shown in FIG. 2, the six arms 120 are formed at equal intervals along the rotation direction R.

That is, the interval between the adjacent arms 120 is 60 degrees.

Further, the cross-sectional shape of the arm 120 orthogonal to the radial direction is a rectangular shape.

At the tip of the arm 120, a columnar upper connecting portion 121 extending vertically upward and a columnar lower connecting portion 122 extending vertically downward are provided.

### <2. Shape of Wing>

Next, the wing will be described in detail with reference to FIGS. 1 to 3.

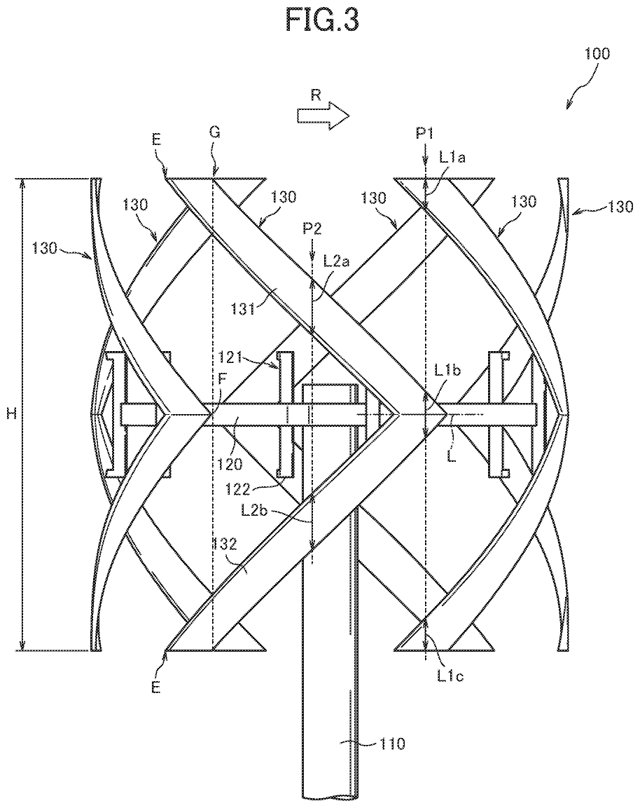

FIG. 3 is a side view of the wind turbine shown in FIG. 1.

The wing 130 is connected to the upper end of the upper connecting portion 121 of the arm 120 and the lower end of the lower connecting portion 122.

More specifically, the wing 130 is connected to the arm 120 at a position slightly away from the center of gravity.

In the present example, the connection point between the arm 120 and the wing 130 is provided near the midpoint between the center of a side view of the wing 130 and the tip of the wing 130, and is located on the tip side of the wing with respect to the center of gravity. However, this connection point depends on the shape of the wing.

As shown in FIG. 2, the cross-sectional shape of the wing 130 is a NACA (National Advisory Committee for Aeronautics) 0012 airfoil, and is the same shape and the same area from the upper end to the lower end in the vertical direction.

That is, the maximum wing thickness of the wing 130 in the present example is 12% of the chord length.

Due to this configuration of the wing 130, lift generated on the wing 130 is substantially uniform in the vertical direction.

The wing 130 has a V shape having a receding angle with respect to the rotation direction R in a side view such as FIG. 3.

That is, the wing 130 is composed of an upper wing 131, which extends upward from the arm 120 and extends in the direction opposite to the rotation direction R, and a lower wing 132, which extends downward from the arm 120 and extends in the direction opposite to the rotation direction R.

The upper wing 131 and the lower wing 132 are symmetrical with respect to the center line L of the wing 130, which extends in the horizontal direction.

Further, the frontmost end F of the wing 130 is located, in the rotation direction, in front of the rearmost end E, which is the rear end of the upper and lower ends, of the adjacent wing 130 on the front side in the rotation direction and almost coincides with the front ends G of the upper and lower ends of the adjacent wing 130 on the front side in the rotation direction.

That is, in a plan view seen from the extending direction of the rotation shaft 110 as shown in FIG. 2, the plurality of the wings 130 are projected on the entire circumference of a single virtual circular ring C whose center is on the rotation shaft 110.

Therefore, the camber of the wing 130 (the difference in the cross section of the wing 130 between the center line of the wing, which connects the front end of and the rear end of the wing, and the chord line of the wing, which is the straight line connecting the front end and the rear end of the wing) is also on the virtual circular ring C.

Due to this configuration of the wing 130, lift generated on the wing 130 is constant at all rotation position of the rotation shaft 110.

The diameter f of the virtual circular ring C is substantially equal to the height H of the wing 130 in the side view (FIG. 3).

Further, as shown in FIG. 3, the lengths of the wings 130 in the vertical direction are equal over the entire circumference.

Specifically, at the position P1 where the adjacent wings 130 overlap each other in the vertical direction, the vertical length L1 of the wing 130 is the sum of the vertical length L1a of the upper wing 131 of the front wing 130 in the rotation direction, the vertical length L1b of the rear wing 130 in the rotation direction and the vertical length L1c of the lower wing 132 of the front wing 130 in the rotation direction.

On the other hand, at the position P2 where the adjacent wings 130 do not overlap each other in the vertical direction, the vertical length L2 of the wing 130 is the sum of the vertical length L2a of the upper wing 131 of the wing 130 and the vertical length L2b of the lower wing 132 of the wing 130.

The vertical length L1 of the wing at the position P1 where the adjacent wings 130 overlap each other in the vertical direction is equal to the vertical length L2 of the wing 130 at the position P2 where the adjacent wings 130 do not overlap each other in the vertical direction.

Due to this configuration of the wings 130, in the wind turbine 100, the area that receives wind pressure from the side direction is constant at all rotation position of the rotation shaft 110.

### Example 2

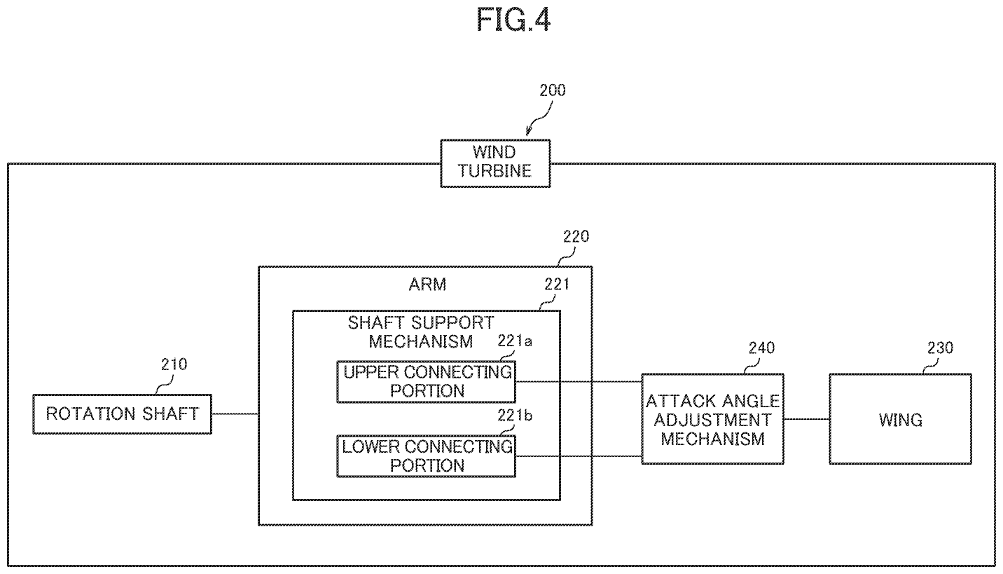

Hereinafter, a wind turbine 200 in the second example of the present invention will be described with reference to FIG. 4.

FIG. 4 is a block diagram of the wind turbine in the second example of the present invention.

In the wind turbine 200 in the second example, the connection form between the arm 120 and the wing 130 in the wind turbine 100 in the first example is modified, but many components are common to the wind turbine 100 in the first example. Therefore, for the common components, detailed explanations will be omitted, and reference signs of the 200s number with the common last two digits will be used.

In the wind turbine 200 in the second example, the arm 220 has a shaft support mechanism 221 at the tip of the arm 220, which rotatably holds a wing 230 and whose rotation axis is in the vertical direction.

As a result, the wing 230 is rotatable with respect to the arm 220.

The wing 230 is connected to the shaft support mechanism 221 by an upper connecting portion 221a formed on the upper end side of the shaft support mechanism 221 and a lower connecting portion 221b formed on the lower end side of the shaft support mechanism 221.

Further, in the wind turbine 200 in the second example, a rotation shaft 210 is rotated by lift generated by the wing 230. However, in strong wind, the rotation speed of the rotation shaft 210 may exceed the allowable rotation speed.

Therefore, the wind turbine 200 in the second example is provided with an attack angle adjustment mechanism 240 between the arm 220 and the wing 230, which is for adjusting the attack angle of the wing 230.

When the rotation speed of the rotation shaft 210 is slower than the predetermined rotation speed, the attack angle adjustment mechanism 240 does not change the attack angle of the wing 230, and when the rotation speed of the rotation shaft 210 becomes the predetermined rotation speed or more, the attack angle adjustment mechanism 240 changes the attack angle of the wing 230 so as to reduce lift generated on the wing 230.

The attack angle adjustment mechanism 240 may be an actuator such as a servomotor or may be an elastic element or a damping element.

Due to this configuration of the wind turbine 200 in the second example, when the rotation speed of the rotation shaft 210 becomes the predetermined rotation speed or more, the attack angle adjustment mechanism 240 changes the attack angle of the wing 230 so as to reduce lift or increase drag generated on the wing 230. Thus, if the rotation speed of the rotation shaft 210 becomes fast in strong wind or the like, lift is reduced. Therefore, increase in the rotation speed of the rotating shaft 210 is suppressed, so that the rotation shaft 210 is less likely to be exhausted, and the durability of the wind turbine 200 can be increased.

Further, the wind turbine 200 in the present example has the connection point between the arm 220 and the wing 230, which is deviated from the center of gravity of the wing 230, and includes the attack angle adjustment mechanism 240. Thus, force to automatically change the attack angle in proportion to the centrifugal force during rotation acts on the wing 230.

Here, even if the attack angle adjustment mechanism 240 has a simple spring-like structure, the attack angle of the wing 230 can be changed, and the increase of the rotation speed of the rotation shaft 210 is suppressed to a constant level.

Changes in wind pressure may affect the spring, but the effect is much smaller than the centrifugal force. Therefore, while the rotation shaft 210 is rotated, the attack angle of the wing 230 rarely pulsates.

Further, the centrifugal force is proportional to the square of the rotation speed. Therefore, in the wind turbine 200 in the present example, the attack angle of the wing 230 hardly changes in the normal wind speed range, and the attack angle of the wing 230 begins to change when the wind exceeds the speed limit. As a result, the rated rotation speed is no longer exceeded even in strong wind.

### [Modified Example]

Although the examples of the present invention have been described above, the present invention is not limited to the above examples.

For example, the cross-sectional shape of the arm is rectangular as shown in FIG. 1 and the like. However, the cross-sectional shape is not limited to this shape, and may be a wing shape, for example.

For example, in the above-described example, the wing 130 is provided in one stage. However, the wings 130 may be provided in multiple stages in the upper/lower direction.

If the wings 130 are provided in multiple stages, all of the rotation directions of the stages are not limited to the same direction, and the wings 130 may be rotated in different directions.

For example, the diameter f of the virtual circular ring C is substantially equal to the height of the wing 130 in the side view (FIG. 3) in the above-described example. However, the diameter φ is not limited to this configuration.

For example, the attack angle adjustment mechanism is provided between the arm 220 and the wing 230 in the second example. However, the wing may have the cross-sectional shape and the material so that when the rotation speed of the rotation axis is less than the predetermined rotation speed, the attack angle of the wing is not changed, and when the rotation speed of the rotation shaft becomes the predetermined rotation speed or more, the shape of the wing is changed and the attack angle of the wing is changed so as to reduce lift generated on the wing.

### REFERENCE SIGNS LIST

100, 200 wind turbine (lift-type vertical shaft wind or water turbine)
110, 210 rotation shaft
120, 220 arm
121 upper connecting portion
122 lower connecting portion
221 shaft support mechanism
221a upper connecting portion
221b lower connecting portion
130, 230 wing
131 upper wing
132 lower wing
240 attack angle adjustment mechanism
R rotation direction
L center line in the upper/lower direction
H height of wing
F frontmost end
E rearmost end
G front end of upper and lower end
C virtual circular ring
f diameter of virtual circular ring

1. A lift-type vertical shaft wind or water turbine comprising:
a rotation shaft extending in the vertical direction;
a plurality of arms extending horizontally from the rotation shaft and formed at equal intervals along the rotation direction; and
a plurality of wings attached to tips of the arms and extending in the upper/lower direction, and
the rotation shaft being rotated by lift generated on the wings, wherein cross sections of the wings have a uniform shape and a uniform area from upper ends of the wings to lower ends of the wings, wherein
seen from the extending direction of the rotation shaft, the plurality of wings are projected on the entire circumference of a single virtual circular ring whose center is on the rotation shaft, and wherein
lengths of the wings in the vertical direction are equal over the entire circumference.

2. The lift-type vertical shaft wind or water turbine according to claim 1, wherein the wing is composed of an upper wing, which extends upward from the arm and extends in the direction opposite to the rotation direction, and a lower wing, which extends downward from the arm and extends in the direction opposite to the rotation direction, and wherein
the shape of the wing is V-shaped in a side view.

3. The lift-type vertical shaft wind or water turbine according to claim 1, wherein the arm has a shaft support mechanism at the tip thereof, which rotatably holds the wing about the vertical direction as a rotation axis, wherein
an attack angle adjustment mechanism for adjusting an attack angle of the wing is provided between the arm and the wing, and wherein
when rotation speed of the rotation shaft is slower than predetermined rotation speed, the attack angle adjustment mechanism does not change the attack angle of the wing, and when the rotation speed of the rotation shaft becomes the predetermined rotation speed or more, the attack angle adjustment mechanism changes the attack angle of the wing so as to reduce lift or increase drag generated on the wing.

4. The lift-type vertical shaft wind or water turbine according to claim 2, wherein the arm has a shaft support mechanism at the tip thereof, which rotatably holds the wing about the vertical direction as a rotation axis, wherein
an attack angle adjustment mechanism for adjusting an attack angle of the wing is provided between the arm and the wing, and wherein
when rotation speed of the rotation shaft is slower than predetermined rotation speed, the attack angle adjustment mechanism does not change the attack angle of the wing, and when the rotation speed of the rotation shaft becomes the predetermined rotation speed or more, the attack angle adjustment mechanism changes the attack angle of the wing so as to reduce lift or increase drag generated on the wing.
